(19) United States
(12) Patent Application Publication
(10) Pub. No.: US 2013/0200855 A1
(43) Pub. Date: Aug. 8, 2013

(54) System and Method for Discharging a Battery in a Vehicle after a Crash

(71) Applicant: Robert Bosch GmbH, Stuttgart (DE)

(72) Inventors: John F. Christensen, Mountain View, CA (US); Horst Muenzel, Cupertino, CA (US); Paul Albertus, Mountain View, CA (US); Alexander Kojic, Sunnyvale, CA (US); Timm Lohmann, Mountain View, CA (US)

(73) Assignee: Robert Bosch GmbH, Stuttgart (DE)

(21) Appl. No.: 13/756,860

(22) Filed: Feb. 1, 2013

Related U.S. Application Data
(60) Provisional application No. 61/594,257, filed on Feb. 2, 2012.
(60) Provisional application No. 61/671,158, filed on Jul. 13, 2012.

(51) Int. Cl. H02J 7/00

(52) U.S. Cl. CPC H02J 7/00
USPC 320/136

(57) ABSTRACT

In one embodiment, a discharge control system for a vehicle includes an energy storage device supported by the vehicle, a switch, a first load selectively connectable to the energy storage device by the switch, a memory in which program instructions are stored, and a controller operatively connected to the switch and the memory and configured to execute the program instructions to control the switch to a condition in which the energy storage device is operatively connected to the first load based upon a predetermined rate of heat generation of the energy storage device.

This application claims the benefit of U.S. Provisional Application No. 61/594,257 filed Feb. 2, 2012, and U.S. Provisional Application No. 61/671,158 filed Jul. 13, 2012, the entire contents of which are both herein incorporated by reference.

### FIELD OF THE INVENTION

This disclosure relates generally to a discharge control system for an energy storage device and, more particularly, to a method and system for controlling discharge from a battery.

### BACKGROUND

Vehicles that contain electrical energy storage devices (e.g., batteries) are susceptible to fire or explosion after sustaining an accident. One risk of such storage devices is the high density of electrical or electrochemical energy stored within them. In the case of a short circuit, which may be caused directly or indirectly by a collision, this energy can be dissipated rapidly within the battery and possibly create ignition sources. Fuel within or in the vicinity of the battery, including flammable electrolytes or electrolyte vapors, can be ignited, causing a fire or explosion.

Accordingly, there is a need for a battery system which is configured to reduce the risk of uncontrolled rapid discharge of a battery. A system which reduces the electrical or electrochemical energy stored in the battery rapidly, while minimizing the risk of fire or explosion would be further beneficial.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Embodiments of the disclosure relate to systems and methods for discharging an energy storage device in a vehicle after a crash. The energy storage device in one embodiment is a battery. One method which discharges the battery includes detecting an occurrence of a vehicle crash event, communicating the event to a controller, and discharging the energy storage device using the controller. One embodiment of a system which embodies the foregoing method includes a relay and a resistor connected to at least one string of cells or modules in the battery. In response to a sensed collision, the system closes a switch in a circuit and thereby causes one or multiple strings of the battery to discharge spontaneously through the circuit. The resistance of a resistor in the circuit is selected based on an internal resistance of the strings such that the discharge current is below a threshold value, I_{crit}. I_{crit} is selected to have a rate of heat generation within the battery and/or circuit below a threshold value, q_{crit}.

Another method which discharges the battery includes detecting an occurrence of a vehicle crash event, communicating the event to a controller, and wirelessly transmitting at least a portion of the energy within the battery out of the vehicle, thereby at least partially discharging the energy storage device using the controller. One embodiment of a system which embodies the foregoing method includes a relay and a transmitter connected to at least one string of cells or modules in the battery. In response to a sensed collision, the system closes a switch in a circuit and thereby causes one or multiple strings of the battery to discharge as energy is transmitted by the transmitter. The transmission power of the transmitter is selected such that the discharge current is below a threshold value, I_{crit}. I_{crit} is selected to have a rate of heat generation within the battery and/or circuit below a threshold value, q_{crit}. The signal that a crash has occurred may be transmitted either via a wire or via a wireless method to initiate discharge of the battery. The signal that a crash has occurred and that the battery should be discharged may be initiated in a number of ways, including through a wireless transmission from the vehicle occupant's mobile device that detects rapid deceleration and transmits a signal wirelessly to the control unit that actuates battery discharge, or via the existing airbag sensor which communicates the need to discharge the battery either via a wired or wireless method.

In one embodiment, a discharge control system for a vehicle includes an energy storage device supported by the vehicle, a switch, a first load selectively connectable to the energy storage device by the switch, a memory in which program instructions are stored, and a controller operatively connected to the switch and the memory and configured to execute the program instructions to control the switch to a condition in which the energy storage device is operatively connected to the first load based upon a predetermined rate of heat generation of the energy storage device.

In another embodiment, a method of discharging an energy storage device supported by a vehicle includes determining a maximum rate of heat generation of the energy storage device, selecting a first load based upon the determined maximum rate of heat generation storing program instructions in a memory, and executing the stored program instructions with a controller to control a switch in the vehicle to a condition in which the energy storage device is operatively connected to the selected first load.

The details of one or more features, aspects, implementations, and advantages of this disclosure are set forth in the accompanying drawings, the detailed description, and the claims below.

### BRIEF DESCRIPTION OF THE DRAWINGS

FIG. 1 is a block diagram representing a system configured to perform the techniques disclosed herein, in accordance with an embodiment;

FIG. 2 is a flowchart describing an embodiment of a method for a technique for discharging an energy storage device in a vehicle; and

FIG. 3 is a block diagram representing a system configured to perform the techniques disclosed herein, in accordance with another embodiment.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such development effort might be complex and time consuming, but would nevertheless be a routine undertaking of design, fabrication, and manufacture for those of ordinary skill having the benefit of this disclosure.

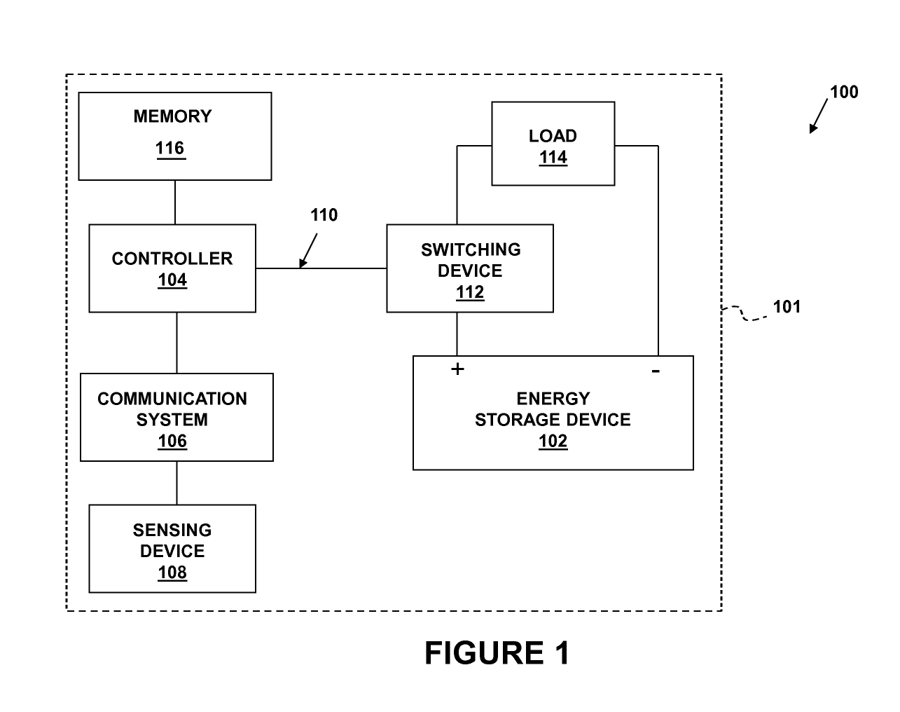

Referring now to FIG. 1, an exemplary embodiment of a discharge control system 100 is depicted located within a vehicle 101. The system 100 includes an energy storage device 102 for accumulating, storing or generating electric energy depending on a state of the system. This energy storage device 102 in one embodiment is a fuel cell, in another embodiment it is an electrical flow battery, in another embodiment it is an electrochemical flow battery, and in another embodiment it is another desired energy storage device. The system 100 also includes a controller 104, a communication system 106, and a sensing system 108 which includes one or more sensing devices. The controller 104 is in communication with the sensing system 108 via the communication system 106.

The sensing system 108 includes at least one sensor mounted in one or more areas around the vehicle 101 for which impact sensing is to be detected. For example, a sensing device in one embodiment is disposed within a door of the vehicle 101 for detecting side impact events. In one embodiment, a sensing device is disposed near or within a front bumper or rear bumper of the vehicle 101. Other locations may, of course, be desirable. No matter where the sensing devices are located, the sensing devices are disposed in a manner that allows detection of a collision event. The sensing devices in the sensing system 108 in various embodiments include one or more of a crash sensor, an electronic sensor, an accelerometer, or other desired sensing devices. The sensing device in some embodiments is one of the air bag crash detection sensors already present in the vehicle. In another embodiment, the sensing device is integrated in a portable device such as a wearable mounted system (glasses, goggles), a smart phone, or any devices wirelessly connected to the vehicle. When the wearable mounted system having a situational awareness feature detects a collision event it communicates the event to the controller to discharge the battery.

The communication system 106 allows the controller 104, the sensing system 108, and other devices (not shown) to communicate with each other. The communication system 106 in one embodiment is a Controller Area Network (CAN) bus, in another embodiment, the communication system 106 is a Local Interconnect Network (LIN) bus, and in yet another embodiment, the communication system 106 is another desired communication system. For example, the communication system in one embodiment is a wireless network that connects sensors to the control unit. Those sensors could be contained on the vehicle (e.g., a wireless crash-detection sensor in a door), or contained in a mobile device carried by a passenger that is connected with the vehicle wireless network.

As illustrated in FIG. 1, the controller 104 is electrically coupled to a switching device 112 (also referred to herein as a “switch”) via an electrical flow path 110. The switching device 112 in one embodiment is a relay, in another embodiment, it is a solid-state switch, in yet another embodiment it is a MOSFET, and in another embodiment it is another desired switching device. A load 114 is provided in the system 100. The load 114 in one embodiment is a variable load resistor, in another embodiment, it is an electric motor, vehicle light, one or more displays, a radio, an electrical heater, resistor, inductor, capacitor, constant-phase element, or another load element, or combination thereof. The controller 104 is further operably coupled to a memory 116 in which programmed instructions are stored.

Through the electrical connection, the controller 104 can open or close the switching device 112 to alter the flow path through the control system 100. For example, if the controller 104 receives information from the sensing device 108 via the CAN bus 106 that there is a collision event, the controller 104 electrically controls the switching device 112 to control the flow of current from the battery 102 through the load 114 based upon the program instructions stored in the memory 116. A portion of heat is dissipated in the energy storage device 102 and a portion of heat is dissipated in the load 114. Accordingly, the system 100 effectively discharges the energy storage device 102 after a crash.

In one embodiment, the system 100 includes a load (not shown) connected to the battery, which defines a “short circuit” and has a sufficiently high impedance to discharge the battery at a current below I_{crit}. For example, the load in one embodiment includes a relay and a resistor connected to at least one string of cells or modules in the battery. The load thus defines a closed short circuit which allows one or multiple strings of cells to discharge in a controlled manner.

In yet another embodiment, the system 100 includes multiple independent circuits with independent loads for independent strings of modules or cells which allow one or multiple strings to discharge in a controlled manner.

In each of the foregoing embodiments, the resistance of the load is selected based upon an internal resistance of the strings such that the discharge current is below a threshold value, I_{crit}. I_{crit} is selected to have a rate of heat generation within the battery and/or circuit below a threshold value, q_{crit}. The value of q_{crit} is associated with a rate of heat generation that is selected so as to ensure combustion of a vapor or fluid does not occur. In one embodiment, the value of q_{crit} is established to ensure a surface temperature is not created that would be dangerous to human touch or to other vehicle components. A heat exchanger may be used to exchange heat between the load and the ambient air in order to keep its temperature within a given range defined by safety for humans and other vehicle components. The heat exchanger may be the principal heat exchanger of the vehicle or may be a separate heat exchanger specifically devoted to the load used to discharge the battery during a crash.

### EXAMPLE

A battery for an electric vehicle in one exemplary embodiment has a capacity of 50 Ah and a nominal equilibrium voltage, U, of 400 V. A typical internal resistance for such a battery is 0.25 Ohm (100 cells at 2.5 mOhm/cell). I_{crit} is chosen in this example to discharge the battery in ˜5 hours, resulting in an I_{crit}=10 A. The load resistance required to discharge the battery is determined according to the following equation:

R_{load}=U/I_{crit}−Rᵢₙₜ

Thus, in this example, R_{load}=400/10−0.25=39.75 Ohm.

The operating voltage during discharge in this example is V=R_{load}*I_{crit}=39.75*10=397.5 V. The rate of heat generation inside the battery is approximately q=(U-V)*I_{crit}=2.5*10=25 W, which is below the heat output of a typical incandescent light bulb.

In embodiments wherein the critical heat load, q_{crit}, is higher, then the value of R_{load} is optionally adjusted to a lower value, resulting in a faster discharge of the battery.

Other embodiments include a variable load resistor that allows for discharge of the battery at a fixed current, or some desirable current profile, throughout the discharge process in accordance with criteria stored in the memory 116. The temperature of the battery in some embodiments is measured and communicated to a potentiostat or similar component that is controlled by the controller 104 to modify the resistance of the internal load, so as to prevent the temperature of the battery from exceeding a set value deemed to be safe. The temperature of the load should also be communicated to the controller so that a temperature is not reached that is deemed unsafe.

In one embodiment, the system includes an alert device and an override function. The alert device in various embodiments is a light or audible alarm that is activated by the controller 104 when a collision has been sensed. A user may then override the controlled discharge by activating the override function which in some embodiments is in the form of a button or other input device. This embodiment allows a user to retain some functionality of the vehicle if needed. In some embodiments, the override function is time limited such that once activated, controlled discharge is merely delayed by a predetermined time. In some embodiments, the override function may be sequentially activated while in other embodiments only a single override is allowed.

In some embodiments, the system 100 is modified to include other sensors which are used to modify the override function. For example, in one embodiment a sensor which senses a breach of the battery vessel is incorporated into the system 100. In instances when a breach of the battery vessel or other unsafe condition is sensed, the system 100 is programmed in some embodiments to ignore the override function.

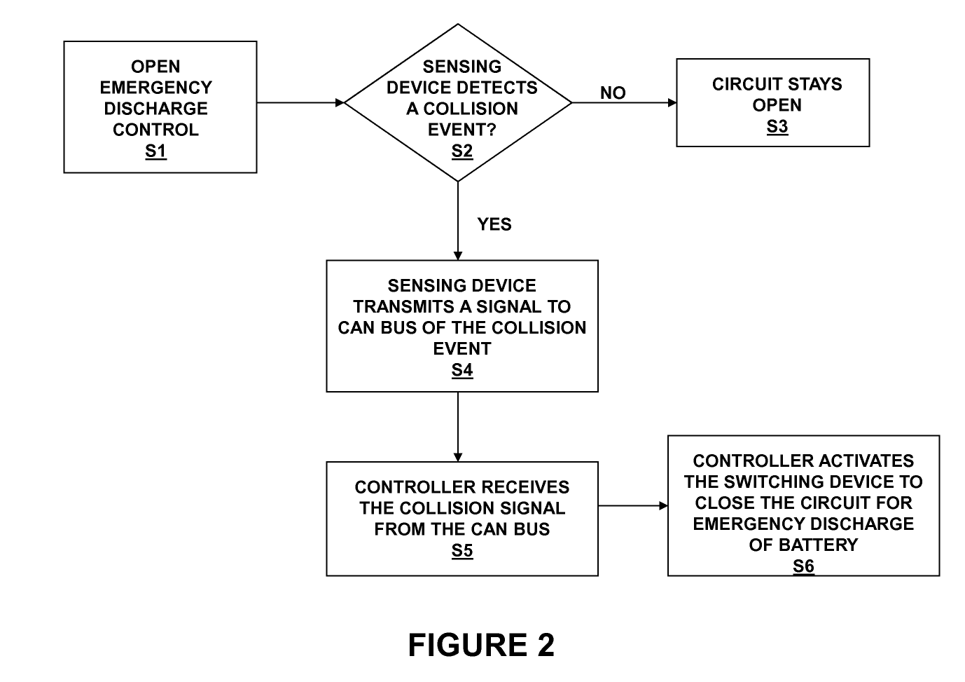

FIG. 2 is a flowchart of one example of an operation procedure of the system 100 performed under the control of the controller 104 based upon program instructions stored in the memory 116. Initially, the emergency discharge circuit (switch device 112) is open (S1). The sensing system 108 monitors for a collision event (S2). The circuit (switch device 112) stays open if the sensing system 108 does not detect any collision event (S3). In the event of a collision, the sensing system 108 transmits a signal to the controller 104 via the CAN bus 106 of the collision event (S4). The controller 104 receives the collision signal and activates the switch device 112 (S5). The switch device 112 closes to initiate a controlled flow of current out of the battery 102 (S6). Heat is dissipated in the energy storage device and in the resistor or load 114. In doing so, the system 100 effectively and safely discharges the energy storage device after a crash.

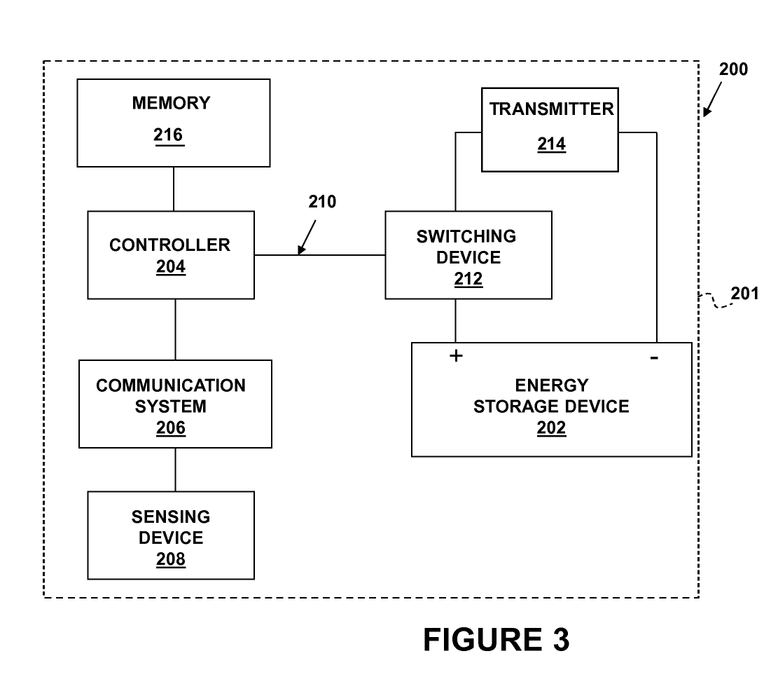

Referring now to FIG. 3, another embodiment of a discharge control system 200 is depicted within a vehicle 201. The system 200 in various embodiments includes an energy storage device 202 for accumulating, storing or generating electric energy depending on a state of the system. This energy storage device 202 in one embodiment is a fuel cell, in another embodiment it is an electrical flow battery, in another embodiment it is an electrochemical flow battery, and in another embodiment it is another desired energy storage device. The system 200 also includes a controller 204, a communication system 206, and a sensing system 208 which includes one or more sensing devices. The controller 204 is in communication with the sensing system 208 via the communication system 206.

The sensing system 208 includes at least one sensor mounted in one or more areas around the vehicle 201 for which impact sensing is to be detected. For example, a sensing device in one embodiment is disposed within a door of the vehicle 201 for detecting side impact events. In one embodiment, a sensing device is disposed near or within a front bumper or rear bumper of the vehicle 201. Other locations may, of course, be desirable. No matter where the sensing devices are located, the sensing devices are disposed in a manner that allows detection of a collision event. The sensing devices in the sensing system 208 in various embodiments include one or more of a crash sensor, an electronic sensor, an accelerometer, or other desired sensing devices. The sensing device may be the airbag sensor of the vehicle, and it may also be a passenger's mobile device that senses rapid deceleration and communicates wirelessly with the controller.

The communication system 206 allows the controller 204, the sensing system 208, and other devices (not shown) to communicate with each other. The communication system 206 in one embodiment is a Controller Area Network (CAN) bus, in another embodiment, the communication system 206 is a Local Interconnect Network (LIN) bus, and in yet another embodiment, the communication system 206 is another desired communication system.

As illustrated in FIG. 3, the controller 204 is electrically coupled to a switching device 212 (also referred to herein as a “switch”) via an electrical flow path 210. The switching device 212 in one embodiment is a relay, in another embodiment, it is a solid-state switch, in yet another embodiment it is a MOSFET, and in another embodiment it is another desired switching device.

The system 200 further includes a load in the form of a transmitter 214. The transmitter 214 in one embodiment is a simple coil. In another embodiment, the transmitter 214 is a tesla coil. The transmitter 214 is thus configured to transmit energy.

Through the electrical connection, the controller 204 can open or close the switching device 212 to alter the flow path through the control system 200 based upon program instructions stored in a memory 216. For example, if the controller 204 receives information from the sensing device 208 via the CAN bus 206 that there is a collision event, the controller 204 electrically controls the switching device 212 based upon program instructions stored in a memory 216 to control the flow of current from the energy storage device 202 through the transmitter 214. A portion of heat is dissipated in the energy storage device 202 and a portion of heat is dissipated in the transmitter 214 as energy is transmitted away from the system 200. Accordingly, the system 200 effectively discharges the energy storage device 202 after a crash.

In one embodiment, resonant coils are located outside of the vehicle. For example, emergency vehicles in some embodiments are equipped with secondary coils. Accordingly, as the transmitter 214 transmits energy, the energy is received by the coils in the emergency vehicles until the battery 202 is sufficiently discharged. In some such embodiments, the controller 204 is located in the emergency vehicle, and wirelessly connected to the switching device 212 located within the damaged vehicle. Accordingly, a command signal is generated by a communication system within the emergency vehicle (not shown) and transmitted to the switching device 212 in the crashed vehicle causing the switching device 212 to allow discharge of the energy storage device 202.

In another embodiment, the system 200 includes multiple independent circuits with independent transmitters for independent strings of modules or cells which allow one or multiple strings to discharge in a controlled manner.

In some embodiments, the system 200 includes loads and/or other components as discussed above with respect to the system 100, such as temperature sensors, alert systems, and override systems.

Operation of the system 200 is substantially identical to the system 100 as discussed above with respect to FIG. 2.

The specific embodiments described above have been shown by way of example, and it should be understood that these embodiments may be susceptible to various modifications and alternative forms. For example, energy storage device includes a built-in wireless transmitter or load to detect heat and then transmit or transfer the heat to an external source, thereby discharging the battery. The transmitter or the load may be encapsulated in a housing of the energy storage device to form a portion of the energy storage device. Further, one or more components such as switch device, controller, or others described above may also be disposed in the housing of the energy storage device. It should be further understood that the claims are not intended to be limited to the particular forms disclosed, but rather to cover all modifications, equivalents, and alternatives falling with the spirit and scope of this disclosure.

1. A discharge control system for a vehicle, comprising:
an energy storage device supported by the vehicle;
a switch;
a first load selectively connectable to the energy storage device by the switch;
a memory in which program instructions are stored; and
a controller operatively connected to the switch and the memory and configured to execute the program instructions to
control the switch to a condition in which the energy storage device is operatively connected to the first load based upon a predetermined rate of heat generation of the energy storage device.

2. The system of claim 1, wherein the controller and the memory are located within the vehicle.

3. The system of claim 1, wherein the controller is located remotely from the vehicle.

4. The system of claim 1, further comprising:
a sensor device configured to sense a collision between the vehicle and another mass, wherein the controller is further configured to execute the program instructions to
receive a signal indicative of a collision event from the sensor device, and
control the switch to a condition in which the energy storage device is operatively connected to the first load based upon the received signal.

5. The system of claim 4 further comprising a temperature sensor, wherein the controller is further configured to execute the program instructions to:
obtain a signal from the temperature sensor indicative of a thermal condition in the vehicle; and
control a potentiostat to modify a resistance of the first load based upon the obtained signal from the temperature sensor.

6. The system of claim 5, further comprising:
a second load selectively connectable to the energy storage device by the switch, wherein the controller is further configured to execute the program instructions to control the switch to a condition in which the energy storage device is operatively connected to the second load based upon the obtained signal from the temperature sensor.

7. The system of claim 6, wherein the first load comprises a tesla coil.

8. The system of claim 6, wherein the switch comprises a relay.

9. The system of claim 6, wherein the switch comprises a solid-state switch.

10. A method of discharging an energy storage device supported by a vehicle, comprising:
determining a maximum rate of heat generation of the energy storage device;
selecting a first load based upon the determined maximum rate of heat generation;
storing program instructions in a memory; and
executing the stored program instructions with a controller to control a switch in the vehicle to a condition in which the energy storage device is operatively connected to the selected first load.

11. The method of claim 10, further comprising:
generating a command signal from a location external to the vehicle; and
controlling the switch using the generated command signal.

12. The method of claim 10, further comprising:
sensing a collision between the vehicle and another mass using a sensor device;
generating a signal indicative of the collision;
receiving the signal indicative of the collision with the controller; and
executing the stored program instructions with the controller based upon the received signal.

13. The method of claim 10 further comprising:
obtaining a signal from a temperature sensor indicative of a thermal condition in the vehicle; and
controlling a potentiostat to modify a resistance of the first load based upon the obtained signal from the temperature sensor.

14. The method of claim 13, further comprising:
controlling the switch to a condition in which the energy storage device is operatively connected to a second load based upon the obtained signal from the temperature sensor.

15. The system of claim 12, wherein selecting a first load comprises selecting a tesla coil.

16. The system of claim 12, wherein selecting a first load comprises selecting a relay.

17. The system of claim 12, wherein selecting a first load comprises selecting a solid-state switch.
